(19) United States
(12) Patent Application Publication
(10) Pub. No.: US 2010/0010858 A1
(43) Pub. Date: Jan. 14, 2010

(54) WORKFLOW EXECUTION CONTROL APPARATUS AND WORKFLOW EXECUTION CONTROL METHOD

(75) Inventor: Kazumine Matoba, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/467,207

(22) Filed: May 15, 2009

(30) Foreign Application Priority Data
Jul. 10, 2008 (JP) 2008-180361

(51) Int. Cl. G06Q 10/00; G06F 9/46

(52) U.S. Cl. 705/8; 718/105

(57) ABSTRACT

A workflow execution control method includes calculating a processing cost and an error occurrence probability for each of the services by acquiring a processing result for each of the services from the service providing servers, calculating for each of the services a normalized cost which is a cost normalized by using the processing cost that occurs in the event of an error in one of the services in order to process other ones of the services and also using the occurrence probability of the error, determining an execution order of the services in accordance with the normalized costs calculated for the services, and sequentially calling the services from the service providing servers in accordance with the execution order.

### CROSS-REFERENCE TO RELATED APPLICATION(S)

This application is based upon and claims the benefit of priority of the prior Japanese Patent Application No. 2008-180361, filed on Jul. 10, 2008, the entire contents of which are incorporated herein by reference.

### FIELD

The present invention relates to workflow control.

### BACKGROUND

When processing a workflow using a computer, a series of processing steps defined in the workflow must be executed along with a transaction. A workflow generally refers to a procedure containing a plurality of processing steps. A transaction refers to processing for maintaining the consistency of the processing result of each application when performing a process across a plurality of applications.

In a conventionally practiced method for workflow processing, the workflow is defined in accordance with BPEL (Business Process Execution Language) or the like, and a service requester calls a service in accordance with the workflow.

When executing a workflow, if a transaction is performed that locks access to a plurality of application services (hereinafter called the “services”) in the workflow in order to execute the plurality of services, the lock period of the resources managed by these services may become long. To address this, there is provided a transaction (called a “long-running transaction”) that executes each service independently and, if a certain service fails to be processed (hereinafter called an “error”), causes other services to execute a compensation transaction (cancellation, rollback, etc.). For example, the compensation transaction is executed in such a manner that when the response results of a certain service matches a specific condition, a request is made to already executed other services to perform processing for cancellation.

A flow control program is proposed that performs a compensation transaction in a workflow process.

Japanese Laid-open Patent Publication No. 2006-195892 is disclosed.

### SUMMARY

According to an aspect of an embodiment, a workflow execution control apparatus for sequentially calling a plurality of services provided by one or more service providing servers is provided. The apparatus includes

a processing cost holding unit for storing an error occurrence probability and a processing cost for each of the services, a service measuring unit for calculating the processing cost and the error occurrence probability for each of the services by using a processing result for each of the services, a normalized cost calculation unit for calculating for each of the services a normalized cost which is a cost normalized by using the processing cost that occurs in the event of an error in one of the services in order to process other ones of the services and also using the occurrence probability of the error, an execution flow determination unit for determining an execution order of the services in accordance with the normalized costs calculated for the services, and a service calling unit for sequentially calling the services from the service providing servers in accordance with the execution order.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of the interconnection configuration of a workflow execution control apparatus.

FIG. 2 is a diagram illustrating one example of the workflow execution control apparatus.

FIG. 3 is a diagram illustrating one example of the process flow of workflow execution control.

FIG. 4 is a diagram illustrating one example of the process flow of workflow execution control.

FIG. 5 is a diagram illustrating one example of the contents of a request message.

FIG. 6 is a diagram illustrating one example of the flow of execution flow determination process.

FIG. 7 is a diagram illustrating one example of execution workflow definition.

FIG. 8 is a diagram illustrating one example of read parameter definition information.

FIG. 9 is a diagram illustrating one example of measurement data.

FIG. 10 is a diagram illustrating one example of the state transition of the execution workflow.

FIG. 11 is a diagram illustrating one example of the workflow execution control apparatus.

FIG. 12 is a diagram illustrating one example of the process flow of workflow execution control.

FIG. 13 is a diagram illustrating one example of the flow of execution flow determination process.

FIG. 14 is a diagram illustrating one example of read parameter definition information.

FIG. 15 is a diagram illustrating one example of execution workflow definition.

FIG. 16 is a diagram illustrating one example of the flow of execution flow determination process.

FIG. 17 is a diagram illustrating one example of the workflow execution control apparatus.

FIG. 18 is a diagram illustrating one example of the processing performed by a service providing server.

FIG. 19 is a diagram illustrating one example of the workflow execution control apparatus.

FIG. 20 is a diagram illustrating one example of a client.

FIG. 21 is a diagram illustrating one example of the transmission format of the request message.

FIG. 22 is a diagram illustrating one example of read parameter definition information.

FIG. 23 is a diagram illustrating one example of the contents of the request message.

FIG. 24 is a diagram illustrating one example of read parameter definition information.

### DESCRIPTION OF EMBODIMENT(S)

The proposed program defines the workflow so that tasks having longer processing times or tasks having lower error occurrence probabilities are executed toward the end of the process. However, while the execution order of the individual tasks is determined in this manner, the execution order of the individual tasks is not determined so as to optimize the execution of the compensation transaction.

According to the workflow execution control program disclosed in the embodiment, a workflow process can be provided that reduces the costs involved with the execution of services and the execution of compensation transactions in the event of an error.

Embodiments will be described below with reference to the drawings.

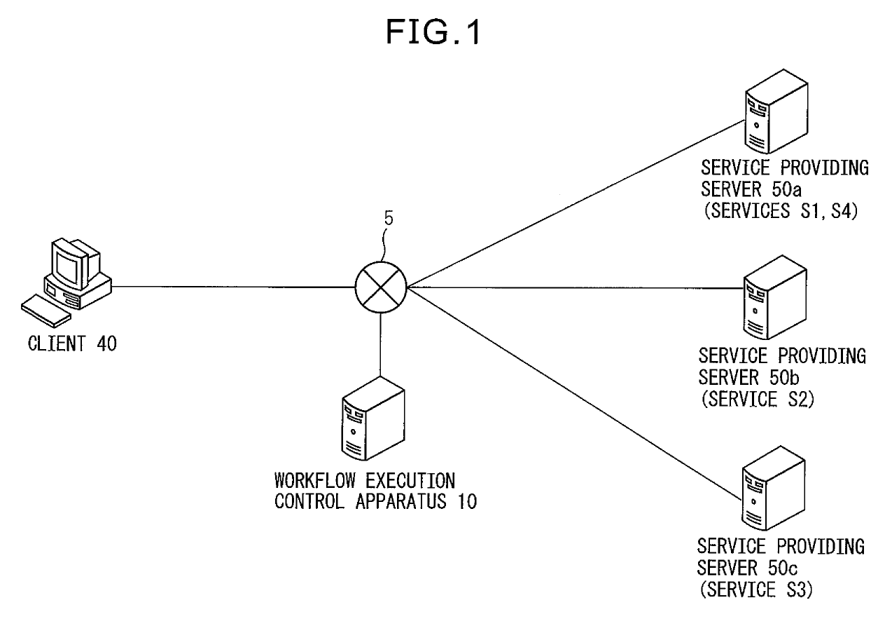

An overview of the interconnection configuration of a workflow execution control apparatus will be described with reference to FIG. 1. The workflow execution control apparatus 10, client computer 40 (hereinafter called the “client 40”), and service providing servers 50a to 50c are interconnected in a mutually accessible manner via a network 5 such as the Internet or a LAN.

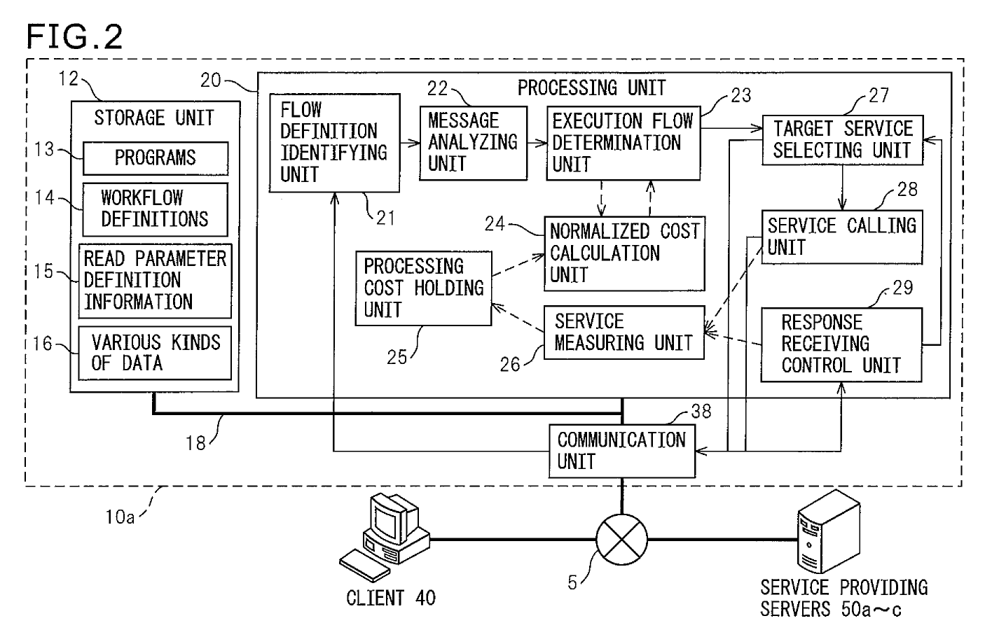

A workflow execution control apparatus 10a according to a first embodiment will be described with reference to FIG. 2.

The workflow execution control apparatus 10a performs workflow execution control for sequentially calling, in response to a request message received from the client 40, a plurality of services provided by one or more service providing servers.

The workflow execution control apparatus 10a includes a processing unit 20 having a single or a plurality of CPUs (Central Processing Units) and a memory (SRAM, DRAM, etc.), a storage unit 12 such as a non-volatile semiconductor memory, a hard disk drive, an optical disk drive, or the like, and a communication unit 38 such as a NIC (Network Interface Card). The workflow execution control apparatus 10a is configured so as to be able to transmit and receive various kinds of data to and from the client 40 and/or the service providing servers 50a to 50c by using known protocols such as HTTP.

The storage unit 12 stores, at a minimum, programs 13 for controlling the operation of the workflow execution control apparatus 10a, workflow definitions 14 as information defining the execution order and/or interdependency of a plurality of services to be processed, read parameter definition information 15, and various kinds of data 16 to be used when performing processing in the processing unit 20. The programs 13 include an operating system, applications, etc.

By executing the programs 13 stored in the storage unit 12, the processing unit 20 functions as a flow definition identifying unit 21, a message analyzing unit 22, an execution flow determination unit 23, a normalized cost calculation unit 24, a service measuring unit 26, a target service selecting unit 27, a service calling unit 28, and a response receiving control unit 29.

The memory in the processing unit 20 or the storage unit 12 functions as a processing cost holding unit 25.

The flow definition identifying unit 21 analyzes the contents of the request message received via the communication unit 38 from the client 40, and reads out the workflow definition 14 corresponding to the request message from the storage unit 12. Here, the request message is a message defining how the requested message should be processed.

The message analyzing unit 22 reads out the read parameter definition information 15 from the storage unit 12, retrieves a parameter (for example, the name of the hotel to be reserved) from the location within the request message specified by the read parameter definition information 15, and passes it to the execution flow determination unit 23. Here, the read parameter definition information 15 can be defined using, for example, “XPath (XML path language).”

The execution flow determination unit 23 identifies from the workflow definition 14 a group of services for which the flow execution order is to be determined, and requests the normalized cost calculation unit 24 to calculate the costs for that service group. The execution flow determination unit 23 receives cost calculation results from the normalized cost calculation unit 24, and determines the execution order of the services in accordance with the decreasing order of the cost. The execution flow determination unit 23 reports the thus determined flow execution order to the target service selecting unit 27.

Based on the service group specified by the execution flow determination unit 23 and the parameter retrieved by the message analyzing unit 22, the normalized cost calculation unit 24 reads out the service processing time, cancellation processing time, and error occurrence probability for each service from the processing cost holding unit 25. The normalized cost calculation unit 24 calculates the normalized cost for each service by using the readout data, and passes the result to the execution flow determination unit 23.

The processing cost holding unit 25 holds the processing cost, i.e., the service processing time and the cancellation processing time, and the error occurrence probability for each service and/or for each parameter (information unit) retrieved by the message analyzing unit 22.

The service measuring unit 26 acquires the time and date of request transmission from the service calling unit 28 and the time and date of response from the response receiving control unit 29, and calculates the processing cost, i.e., the service processing time and the cancellation processing time, for each service and/or for each parameter retrieved by the message analyzing unit 22. Then, the service measuring unit 26 stores the processing cost in the processing cost holding unit 25. Further, the service measuring unit 26 acquires from the response receiving control unit 29 the processing result of the service from the service providing server 50, and identifies whether the processing result shows “OK” or “ERROR.” If the processing result shows “ERROR,” the service measuring unit 26 recalculates the error occurrence probability, and stores the error occurrence probability in the processing cost holding unit 25 along with the processing cost.

The target service selecting unit 27 determines the service to be called in accordance with the flow execution order determined by the execution flow determination unit 23. Further, the target service selecting unit 27 manages the state of each workflow being executed, and determines whether to call a cancellation process in the event of an error.

The service calling unit 28 transmits a service execution request for requesting the execution of the service determined in accordance with the flow execution order, via the communication unit 38 to the service providing server 50 providing that service, and thus calls the service from the service providing server 50. Further, the service calling unit 28 notifies the service measuring unit 26 of the time and date of request transmission, i.e., the time and date at which the service execution request was transmitted.

The response receiving control unit 29 receives the processing result from the service providing server 50 via the communication unit 38, and passes it to the target service selecting unit 27. Using the processing result, the response receiving control unit 29 notifies the service measuring unit 26 of the time and date of response, i.e., the time and date at which the processing result was received.

The client 40 sends a request message to the workflow execution control apparatus 10a to request the use of ASP services that the service providing servers 50a to 50c can provide.

The client 40 includes a display unit such as a liquid crystal display, an operation unit such as a keyboard and mouse, a processing unit having a CPU, memory, etc., a storage unit such as a hard disk, and a communication unit such as a NIC, and is configured so as to be able to transmit and receive various kinds of data to and from the workflow execution control apparatus 10a and/or the service providing servers 50a to 50c via the network 5.

A web browser for accessing web pages maintained at web sites is installed on the client 40. The client 40 may be a personal computer, a browser phone, or a PDA (Personal Digital Assistant). In FIG. 1, only one client 40 is shown, but more than one may be provided.

The service providing servers 50a to 50c may be servers for providing ASP services. Each of the service providing servers 50a to 50c includes a processing unit having a CPU, memory, etc., a storage unit such as a hard disk, and a communication unit such as a NIC. The service providing servers 50a to 50c provide services S1 to S3, i.e., ASP services, to the client 40. The service providing servers 50a to 50c are also configured so as to be able to transmit and receive various kinds of data to and from the workflow execution control apparatus 10a and the client 40 via the network 5.

In FIG. 1, three service providing servers are shown, but the number of servers is not limited to this particular number. The number of service providing servers may be reduced by configuring a single server so as to be able to provide a plurality of services.

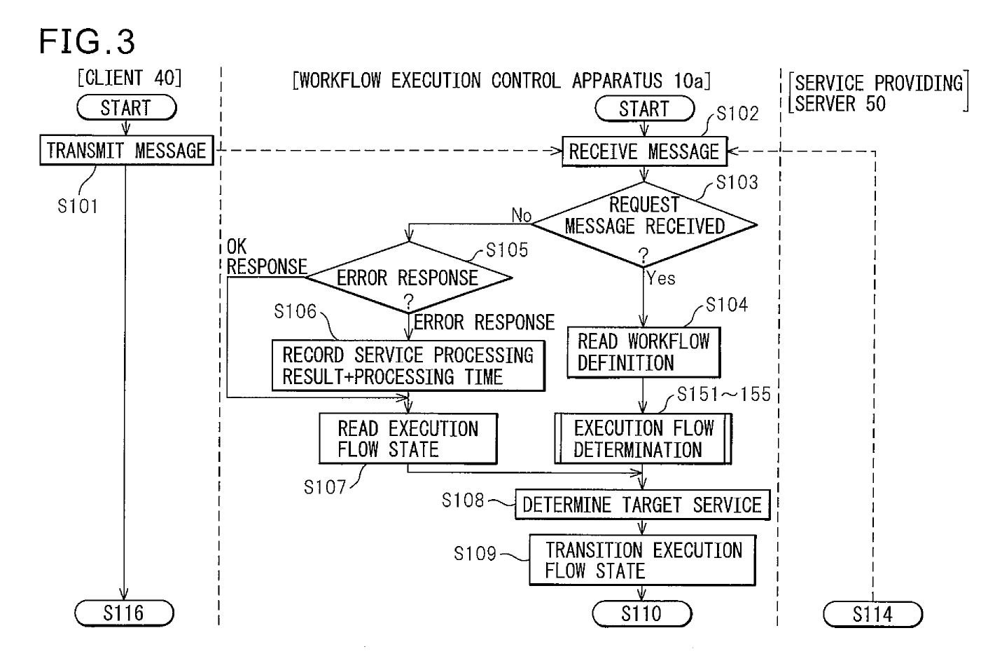

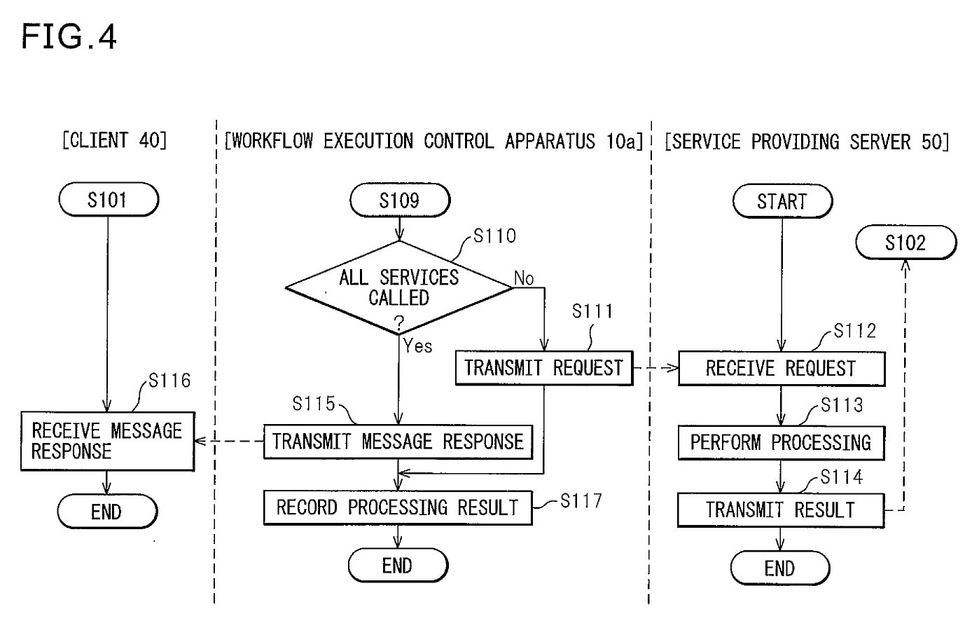

One example of the process flow of workflow execution control will be described with reference to FIGS. 3 and 4.

In FIGS. 3 and 4, the client 40, the workflow execution control apparatus 10a, and the service providing server 50 start their respective processes, that is, ASP service request, workflow execution control, and service processing, respectively. In FIGS. 3 and 4, the process flow within each apparatus is indicated by solid lines, and data transfers between the respective apparatuses are indicated by dashed lines.

One example of the ASP service request process flow performed by the client 40 will be described with reference to FIGS. 3 and 4.

First, the client 40 starts the ASP service request process and transmits a request message to the workflow execution control apparatus 10a to request the use of ASP services that the service providing servers 50a to 50c can provide (step S101). The client 40 receives from the workflow execution control apparatus 10a a message response indicating whether the workflow defined in the request message has been executed properly or whether any service has responded with an error (step S116); after that, the client 40 terminates the ASP service request process.

One example of the process flow of the workflow execution control performed by the workflow execution control apparatus 10a will be described with reference to FIGS. 3 and 4.

The workflow execution control apparatus 10a starts the workflow execution control process in response to the request message received from the client 40. First, the communication unit 38 in the workflow execution control apparatus 10a receives the request message transmitted from the client 40 (step S102). In step S102, the communication unit 38 in the workflow execution control apparatus 10a also receives the processing result (OK or ERROR) returned in response to the request transmitted to the service providing servers 50a to 50c (see step S114 to be described later).

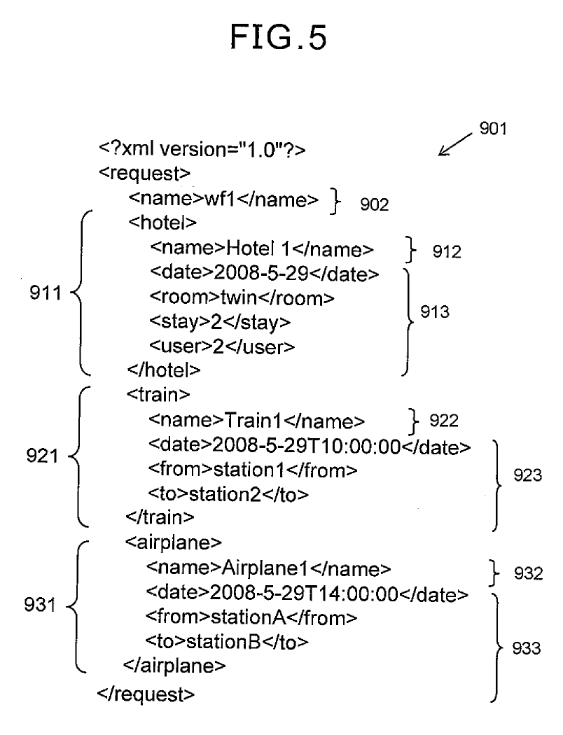

FIG. 5 illustrates one example of the contents of the request message transmitted in step S101. The request message is a message specifying how the requested services should be processed. As illustrated, the request message 901 can be defined in XML format. In the request message 901, the name “wf1” of the workflow defined in the request message is shown by being bounded by <name> tags indicated at 902. The request message 901 includes request descriptions 911, 921, and 931 for the respective services S1, S2, and S3 to be executed in the service providing server 50. The request descriptions 911, 921, and 931 include reservation resources, called request units or service units, as parameters bounded by <name> tags indicated at 912, 922, and 932, respectively, and further include request specification information indicated at 913, 923, and 933, respectively.

For example, in the request description 911, the reservation resource (also called the “request information unit”) 912 is “Hotel 1” and the request specification information 913 is the specification (date, room type, and number of persons) of the reservation resource for the requested service. In the request description 921, the reservation resource 922 is “Train 1,” and the request specification information 923 is the specification (date, starting station, and destination station) of the reservation resource for the requested service. In the request description 931, the reservation resource 932 is “Airplane 1,” and the request specification information 933 is the specification (date, starting airport, and destination airport) of the reservation resource for the requested service.

In step S103, the workflow execution control apparatus 10a checks the message received in step S102 to determine whether it is the request message from the client 40 or the processing result from the service providing server 50 (step S103). If the received message is the request message, the process proceeds to step S104. If the received message is the processing result from the service providing server 50, the process proceeds to step S105.

In step S104, the flow definition identifying unit 21 reads the workflow name “wf1” contained in the request message 901, retrieves the workflow definition associated with the workflow name, and executes the execution flow determination process (steps S151 to S155).

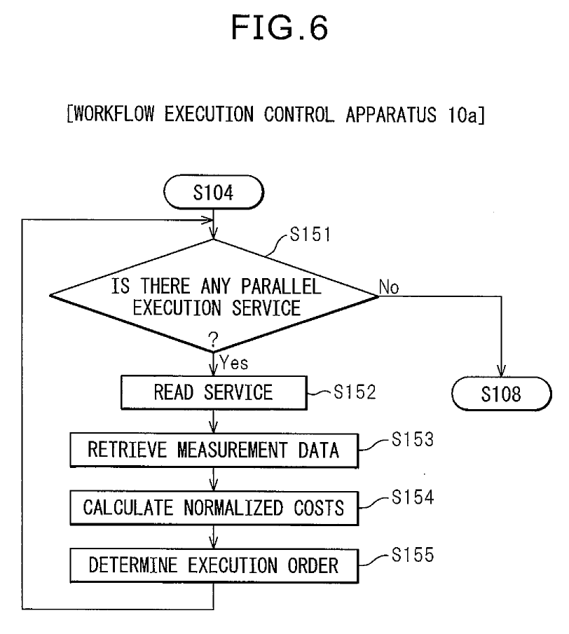

One example of the execution flow determination process flow will be described with reference to FIG. 6. First, the message analyzing unit 22 checks the workflow definition retrieved in step S104 for the presence or absence of a parallel execution service. Here, the “parallel execution service” is a service that has no inter-service dependency that restricts the execution order.

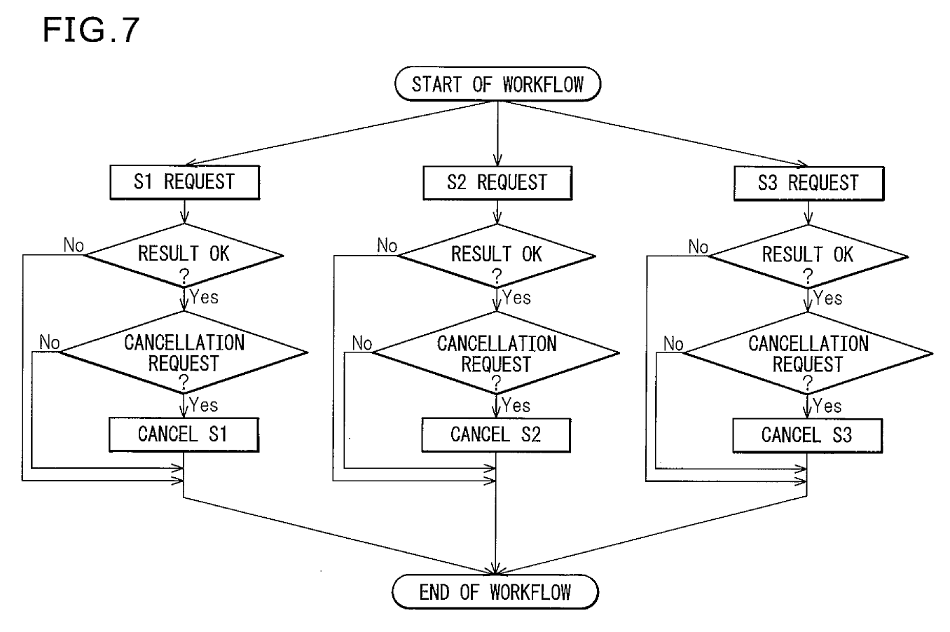

FIG. 7 is a diagram illustrating one example of the execution order and interdependent relationship between the plurality of services, as defined by the workflow definition 14. As illustrated, in the workflow definition 14, the services S1, S2, and S3 are placed in parallel with each other so that they have no interdependent relationship that provides for preprocessing, postprocessing, etc. of the execution process. That is, the work definition 14 defines the respective services S1, S2, and S3 as parallel execution services. When the workflow process is started, and the request is transmitted to each service, the service receives the result (OK or ERROR); in the case of ERROR, the process is terminated, but in the case of OK, the process waits for a cancellation request. If a cancellation request is not received, the service request process is terminated, terminating the workflow process. If a cancellation request is received, the service performs the cancellation processing, after which the service request process is terminated, terminating the workflow process. The workflow definition illustrated here can be described using BPEL or the like.

If there is any parallel execution service, the process proceeds to step S152, but if there is no parallel execution service, the execution flow determination process is terminated, and the process proceeds to step S108.

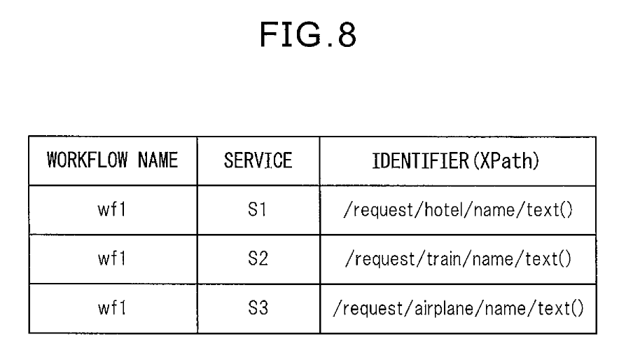

In step S152, the message analyzing unit 22 reads out the reservation resources 912, 922, and 932. Xpath in the read parameter definition information 15 illustrated in FIG. 8 can be used to call the reservation resources 912, 922, and 932 from the request message 901. As illustrated in FIG. 8, the services S1, S2, and S3 defined in the workflow definition 14 are associated with the services “hotel”, “train” and “airplane” contained in Xpath in the read parameter definition information 15.

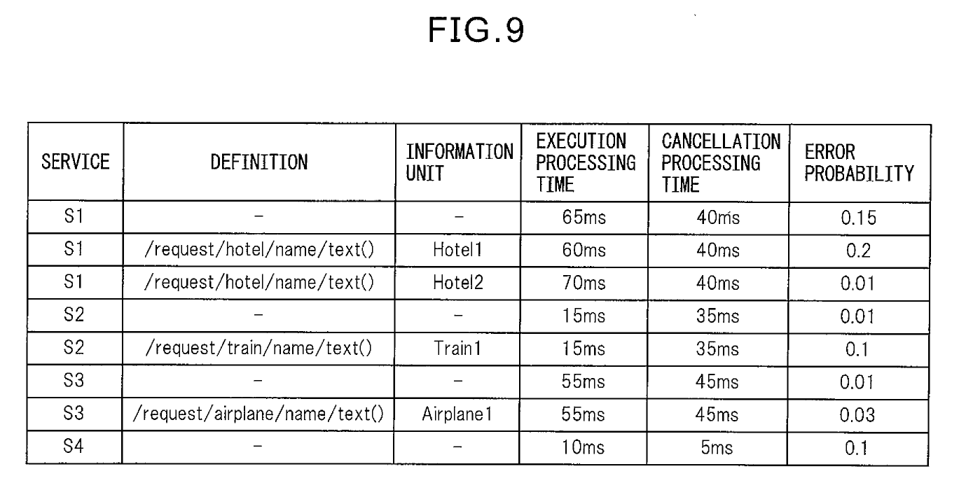

The execution flow determination unit 23 requests the normalized cost calculation unit 24 to calculate the normalized costs for the respective services S1, S2, and S3. The normalized cost calculation unit 24 retrieves from the processing cost holding unit 25 the measurement data of the respective services S1, S2, and S3 (service processing time, cancellation processing time, and error occurrence probability for each service) necessary for the calculation of the normalized costs (step S153). FIG. 9 illustrates one example of the measurement data. As illustrated, the processing cost holding unit 25 holds the measurement data (service processing time, cancellation processing time, and error occurrence probability for each service) for each reservation resource. These measurement data are corrected as appropriate by the service measuring unit 26 (as will be described later).

The normalized cost calculation unit 24 calculates the normalized costs (step S154). The normalized cost is data normalized by using the processing cost that occurs in the event of an error in one of the services in order to process other ones of the services and also using the occurrence probability of the error, and is a metric for quantitatively evaluating the magnitude of a fault when an error occurs in a service. In the present embodiment, the processing cost is defined as the cancellation processing time that occurs in the event of an error in one of the services in order to cancel other ones of the services and the processing time required to execute those other services. Accordingly, the normalized cost can be calculated based on the cancellation processing time of the already executed services when the service to be subsequently executed has become unable to be executed due to an error, the service processing time of the already executed services, and the probability of occurrence of the error. In this case, the normalized cost of one service can be defined by the following equation.

(Normalized cost)=(Cancellation processing time of already executed other services+Service processing time of already executed other services)×(Probability of occurrence of error) (Equation 1)

FIG. 9 illustrates one example of the measurement data that the service measuring unit 26 manages. The normalized costs calculated for the respective services S1 (Hotel 1), S2 (Train 1), and S3 (Airplane 1) using Equation 1 are calculated as shown below from the measurement data illustrated in FIG. 9.

Normalized cost for S1 (Hotel 1)=(Cancellation processing time of S2 (Train 1)+Service processing time of S2 (Train 1)+Cancellation processing time of S3 (Airplane 1)+Service processing time of S3 (Airplane 1))×(Probability of occurrence of error of S1 (Hotel 1))=(50+100)×0.2=30

Normalized cost for S2 (Train 1)=(Cancellation processing time of S1 (Hotel 1)+Service processing time of S1 (Hotel 1)+Cancellation processing time of S3 (Airplane 1)+Service processing time of S3 (Airplane 1))×(Probability of occurrence of error of S2 (Train 1))=(100+100)×0.1=20

Normalized cost for S3 (Airplane 1)=(Cancellation processing time of S1 (Hotel 1)+Service processing time of S1 (Hotel 1)+Cancellation processing time of S2 (Train 1)+Service processing time of S2 (Train 1))×(Probability of occurrence of error of S3 (Airplane 1))=(100+50)×0.03=4.5

Based on the thus calculated normalized costs, the execution flow determination unit 23 determines the execution flow in accordance with the decreasing order of the cost (step S155). In the above example, the execution flow order is determined to be S1, S2, and S3.

In this way, by determining the execution flow of the plurality of services in accordance with their normalized costs, the present embodiment can provide the workflow process that optimizes the execution of the compensation transaction. As a result, the workflow execution control apparatus can reduce the processing cost that occurs in the event of an error in the service providing server. Further, by thus optimizing the execution of the compensation transaction and reducing the processing cost, the workflow execution control apparatus can reduce the processing load of the CPU of the service providing servers.

Furthermore, since not only the normalized costs but the interdependencies defined in the workflow definition can also be reflected in the execution order of the services, the actual service execution order can be determined in a flexible manner.

Next, the process returns to step S151, and if there is any other parallel execution service, steps S152 to S155 are repeated; if there is no parallel execution service, the process proceeds to step S108 in FIG. 3.

In step S105, it is determined whether the processing result returned from the service providing server 50 is an ERROR response (which includes the processing result of cancellation processing) or an OK response. If it is an ERROR response, the process proceeds to step S106; on the other hand, if it is an OK response, the process proceeds to step S107.

In step S106, the service measuring unit 26 updates the error occurrence probability in accordance with the ERROR response, and also updates the cancellation processing time if cancellation processing has been executed. In a specific example, the response receiving control unit 29 notifies the service measuring unit 26 of the processing result (ERROR) and the time and date at which the result of calling the service S1 “Hotel 1” included in the processing result received from the service providing server, was received (example: 2008.5.24 10:00:00.30). Then, the service measuring unit 26 updates the error occurrence probability and the average processing time in the corresponding entry “Hotel 1” of the service S1 in the processing cost holding unit 25. For example, if the processing time averaged over the past 10 times is 50 ms, and the current processing time is 30 ms, the average processing time is updated to (50×10+30)/11=48 ms. Further, if the error occurrence probability averaged over the past 10 times is 0.2, for example, then it is updated to (10×0.2+1)/11=0.27. Since the request processing has ended in an error, the target service selecting unit 27 terminates the processing in accordance with the workflow.

In step S107, the execution flow determination unit 23 reads out the most recent execution order updated in step S109 to be described later.

In step S108, the target service selecting unit 27 identifies the target service to be requested, in accordance with the service execution order received from the execution flow determination unit 23.

The execution flow determination unit 23 causes the execution workflow to transition from one state to the next (step S109).

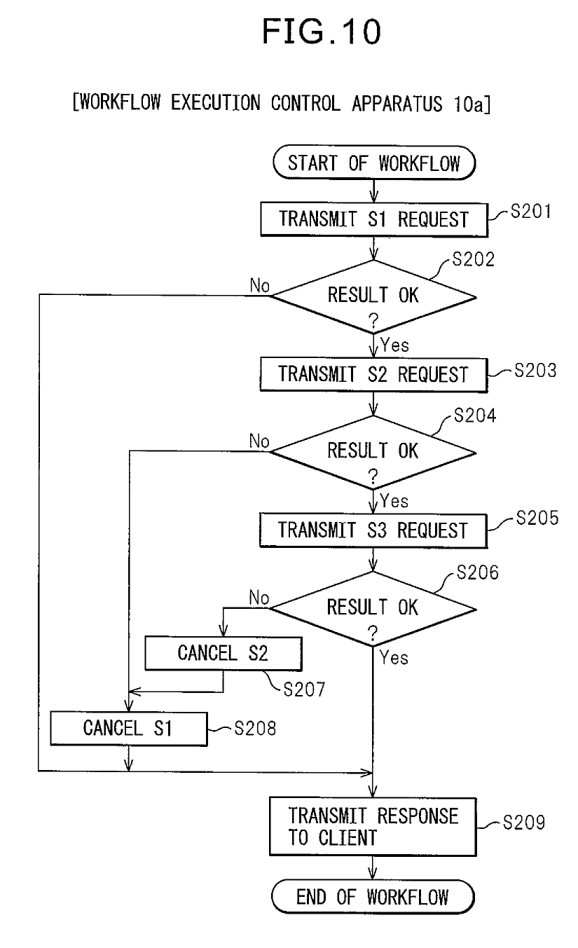

One example of the state transition of the execution workflow will be described with reference to FIG. 10. Since the service execution order is determined to be S1, S2, and S3 based on the calculation results from the normalized cost calculation unit 24, the service execution requests for the respective services S1, S2, and S3 are transmitted in steps S201, S203, and S205, respectively.

In step S202, if the processing result of the service S1 request shows OK, the process follows the YES branch of step S202 to proceed to the transmission of the service S2 request (step S203) and the decision concerning the processing result of the service S2 request (step S204). On the other hand, if the processing result of the service S1 request shows an error, the process follows the NO branch of step S202 to proceed to step S209. In step S209, a message response containing data indicating that the processing result of the service S1 request shows an error is returned to the client 40.

In step S204, if the processing result of the service S2 request shows OK, the process follows the YES branch of step S204 to proceed to the transmission of the service S3 request (step S205) and the decision concerning the processing result of the service S3 request (step S206). On the other hand, if the processing result of the service S2 request shows an error, the process follows the NO branch of step S204 to proceed to step S208 where processing is performed to cancel the service S1 request. In step S209, a message response indicating that the processing result of the service S2 request shows an error and that the service S1 request has been canceled is returned to the client 40.

In step S206, if the processing result of the service S3 request shows OK, the process follows the YES branch of step S206 to proceed to step S209. In this case, a message response indicating that the request processing results for the services S1, S2, and S3 all show OK is returned to the client 40.

In step S206, if the processing result of the service S3 request shows an error, the process follows the NO branch of step S206. In this case, the process proceeds to step S207 to perform processing for canceling the service S2 request, and then proceeds to step S208 to perform processing for canceling the service S1 request. In step S209, a message response indicating that the processing result of the service S3 request shows an error and that the service S1 request as well as the service S2 request has been canceled is returned to the client 40.

The above steps S202, S204, and S206 are each carried out by the target service selecting unit 27 upon reception of the corresponding processing result from the service providing server (step S102), and are each managed as the execution flow state. This execution flow state is read in step S107 as earlier described.

The target service selecting unit 27 monitors the execution flow state, and determines whether the calling process (request transmission process) has been completed for all the services (step S110). If the calling process has been completed for all the services, the process proceeds to S115, but if the calling process has not yet been completed for all the services, the process proceeds to step S111.

In step S111, the service calling unit 28 transmits the service execution request for the corresponding one of the services S1, S2, and S3. This service execution request contains the request specification information 913, 923, or 933 for the corresponding one of the services S1, S2, and S3.

In step S115, as in step S209, the workflow execution control apparatus 10a returns to the client 40 a message response indicating whether the workflow defined in the request message has been executed properly or whether any service has responded with an error. The client 40 receives the message response from the workflow execution control apparatus 10a (step S116).

In step S117, the service calling unit 28 reports the time and date of the request transmission (for example, 2008.5.24 10:00:00.00) to the service measuring unit 26, after which the process flow of the workflow execution control by the workflow execution control apparatus 10a is determined.

One example of the process flow for service processing performed by the service providing server 50 will be described with reference to FIGS. 3 and 4.

The service providing servers 50a to 50c each start the service processing in accordance with the service execution request received from the workflow execution control apparatus 10a.

First, the service providing servers 50a to 50c each receive the service execution request from the workflow execution control apparatus 10a (step S112), and perform the service processing in accordance with the service execution request (step S113). Next, the service providing servers 50a to 50c each transmit the processing result of the service processing (OK or ERROR) to the workflow execution control apparatus 10a (step S114), after which the service processing is terminated.

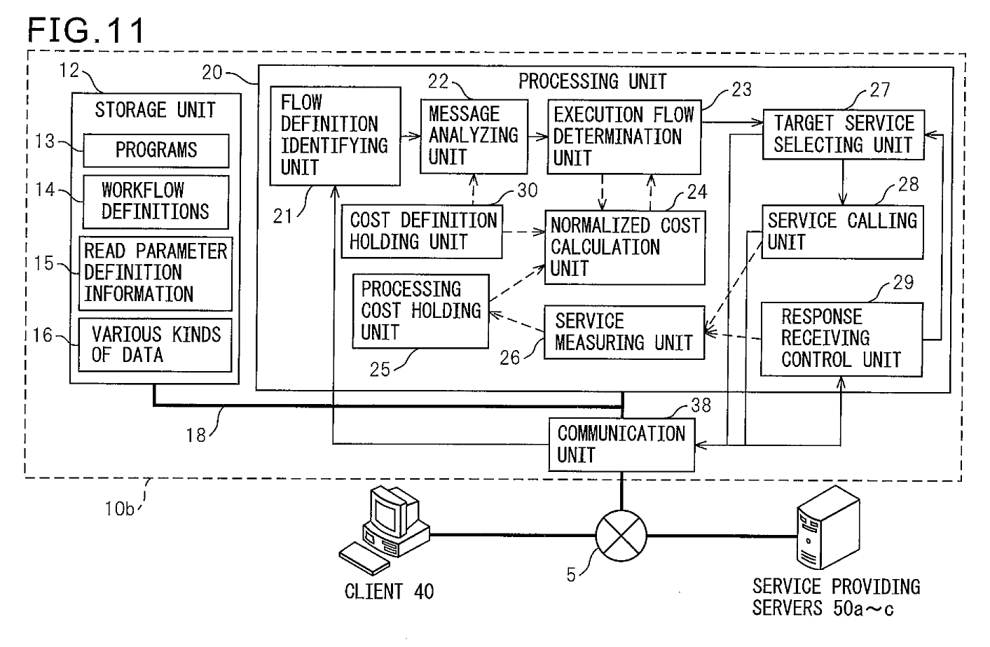

A workflow execution control apparatus 10b according to a second embodiment will be described with reference to FIG. 11.

The workflow execution control apparatus 10b is identical in configuration to the workflow execution control apparatus 10a of the first embodiment, the only difference being the inclusion of a cost definition holding unit 30 for holding cost definition that is used to set and hold the cost definition for normalization.

The workflow execution control apparatus 10b holds the cost definitions by causing the memory in the processing unit 20 or the storage unit 12 to function as the cost definition holding unit 30. For example, in the case of the resource reservation, the time limit for canceling the resource (hereinafter called the “cancellation time limit”), the cancellation cost, and the location indicating the reservation date within the request message are defined as the cost definition by using XPath (to be described later). Here, the administrator of the workflow execution control apparatus 10b can manually enter the cancellation cost using an input unit (not shown) in accordance with the agreement, etc. made in advance with the service providing server operator concerning the payment of cost associated with cancellation.

The message analyzing unit 22 can retrieve the parameter (example: resource reservation date) necessary for the cost calculation from the request message in accordance with the definition held in the cost definition holding unit 30, and can pass it to the execution flow determination unit 23. Further, the normalized cost calculation unit 24 calculates the processing cost in the event of an error in accordance with the definition held in the cost definition holding unit 30. In the present embodiment, the processing cost is the cancellation cost that occurs in the event of an error in one of the services in order to cancel other ones of the services.

The normalized cost calculation unit 24 reads out the error occurrence probability for each service from the processing cost holding unit 25, calculates the normalized cost for each service, and passes the result to the execution flow determination unit 23.

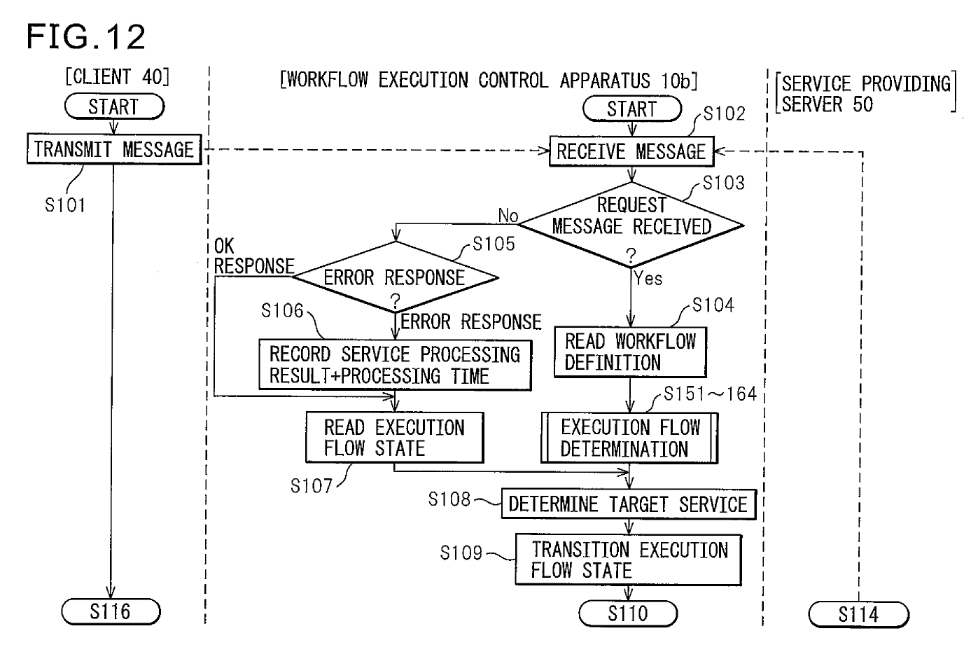

One example of the process flow of the workflow execution control will be described with reference to FIG. 12.

Steps S101 to S109 shown in FIG. 12 are the same as the corresponding steps shown in FIG. 3, and therefore, the description will not be repeated here. The difference from the first embodiment lies in the execution flow determination process (steps S151 to S164).

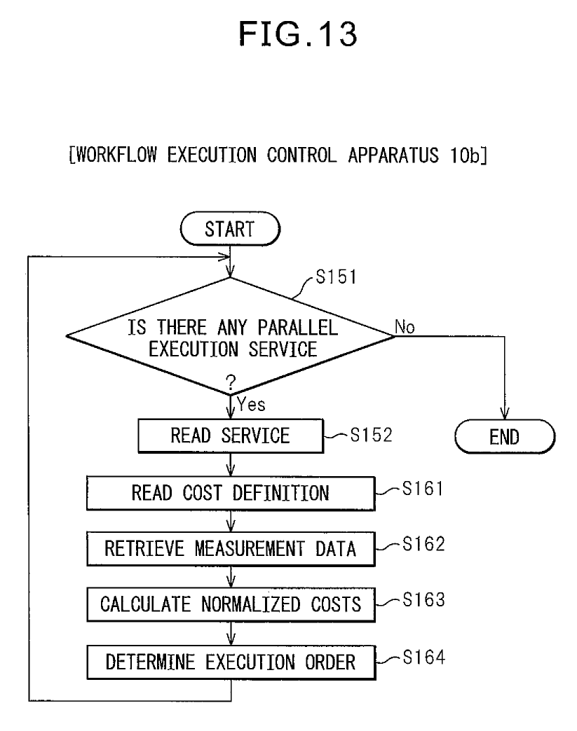

One example of the execution flow determination process will be described with reference to FIG. 13.

Steps S151 and S152 shown in FIG. 13 are the same as the corresponding steps shown in FIG. 6, and therefore, the description will not be repeated here.

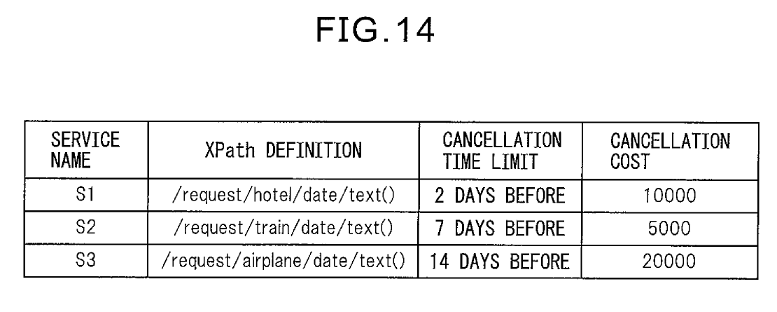

In step S161, the message analyzing unit 22 reads out the cost definition from the cost definition holding unit 30. One example of the cost definition for evaluating the effect of the cost that occurs in the event of a cancellation will be described with reference to FIG. 14. As illustrated, the cancellation time limit, the cancellation cost, and the location indicating the reservation date within the request message are defined using Xpath. In the present embodiment, the cancellation time limit is determined from the time/date information of the reserved resource and the current time and date (example: 2008-5-24 10:00:00).

The message analyzing unit 22 reads out the reservation time/date information from the received request message (step S162). The readout results are, for example, Hotel 1=2008-5-29, Train 1=2008-5-29 10:00:00, and Airplane 1=2008-5-29 14:00:00.

The normalized cost calculation unit 24 calculates the normalized costs for the respective services S1 (Hotel 1), S2 (Train 1), and S3 (Airplane 1).

As described above, the processing cost is defined as the cancellation cost that occurs in the event of an error in one of the services in order to cancel other ones of the services. Accordingly, the normalized cost is calculated based on the cancellation cost of the already executed services when the service to be subsequently executed has become unable to be executed due to an error and on the probability of occurrence of the error. In this case, the normalized cost is defined by the following equation.

(Normalized cost)=(Cancellation cost of already executed other services)×(Probability of occurrence of error) (Equation 2)

The normalized cost of the service S1 is calculated by multiplying the sum of the processing costs of the other services multiplied by the error occurrence probability of S1. In the present embodiment, since the cancellation costs occur only for S2 and S3, the normalization costs of the respective services are given as S1=(20000+5000)×0.5=5000, S2=(0+20000)×0.1=2000, and S3=(0+5000)×0.03=150.

Based on the thus calculated normalized costs, the execution flow determination unit 23 determines the flow in accordance with the decreasing order of the cost. In the present embodiment, the execution order is determined to be S1, S2, and S3 (step S164).

Next, the process returns to step S151, and if there is any other parallel execution service, steps S152 to S164 are repeated; if there is no parallel execution service, the process proceeds to step S108 in FIG. 12.

In this way, by determining the execution flow of the plurality of services in accordance with the normalized costs calculated using the cost definition of “cancellation time limit,” “cancellation cost,” etc., the present embodiment can provide the workflow process that optimizes the execution of the compensation transaction. The workflow execution control apparatus can thus reduce the processing cost that occurs in the event of an error in the service providing server.

A workflow execution control apparatus 10c according to a third embodiment is identical in configuration to the workflow execution control apparatus 10a of the first embodiment.

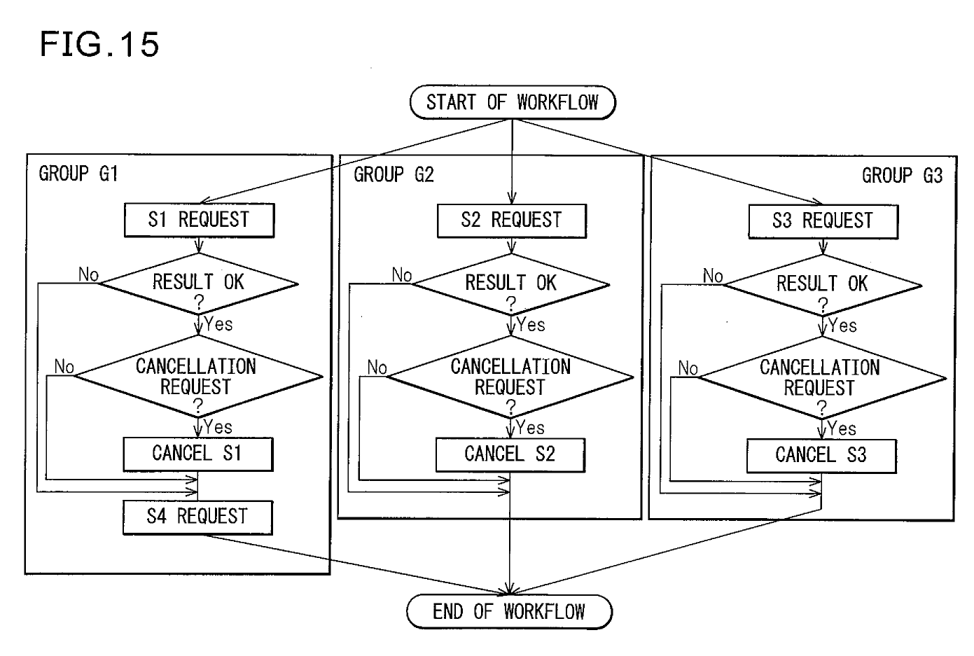

In the present embodiment, the service execution order is determined by using the workflow definition created by dividing the services into groups. One example of the workflow definition 14 will be described with reference to FIG. 15. As illustrated, in the workflow definition 14, the groups G1, G2, and G3 are independent of each other, but the services S1 and S4 in the group G1 are defined as having a hierarchical relationship. In the present embodiment, it is assumed that the service S4 is a service for reporting the processing result of the service S1 by email and is executed immediately following the service S1. The workflow definition illustrated here can be described using BPEL or the like.

Compared with the first embodiment, the normalized cost calculation unit 24 and the execution flow determination unit 23 further include the following functions.

When a plurality of services are defined by grouping them together, the normalized cost calculation unit 24 calculates the normalized cost by regarding the services in the same group as a single service, and passes the result to the execution flow determination unit.

The execution flow determination unit 23 receives the cost calculation results from the normalized cost calculation unit 24, and determines the execution order between the groups. The thus determined final execution order of the services is reported to the target service selection unit 27.

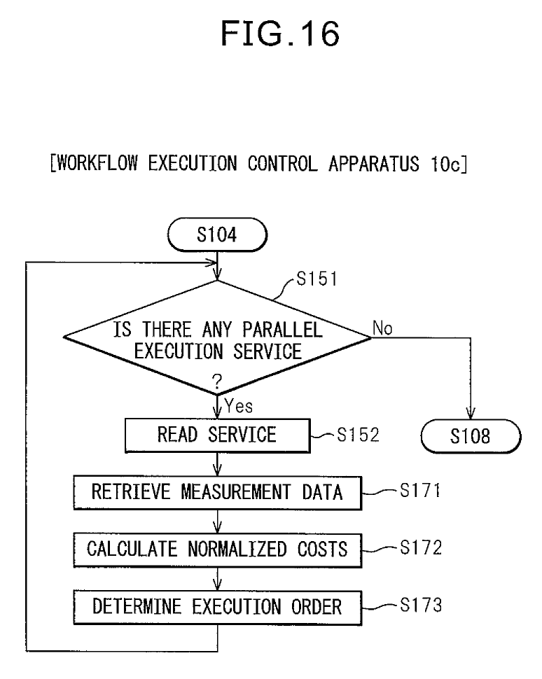

Since the difference from the first embodiment lies in the execution flow determination process, the execution flow determination process of the present embodiment will be described with reference to FIG. 16. Steps S151 and S152 shown in FIG. 16 are the same as the corresponding steps shown in FIG. 6, and therefore, the description will not be repeated here.

In step S171, the message analyzing unit 22 reads out the information of the reservation resources, Hotel 1, Train 1, and Airplane 1, from the received request message. For the service S4, no information is read out since there is no definition as to the read location.

The execution flow determination unit 23 requests the normalized cost calculation unit 24 to calculate the normalized costs for the respective groups G1 (services S1 and S4), G2 (service S2), and G3 (service S3) which are defined as interchangeable processes by wf1.

The normalized cost calculation unit 24 calculates the normalized costs for the respective groups G1, G2, and G3 (step S172). In the present embodiment, it is assumed that the execution time, cancellation processing time, and error occurrence probability for each service are defined as shown in FIG. 9. The normalized cost of the group G2, for example, is calculated by multiplying the sum of the processing costs of the other services S1, S3, and S4 by the error occurrence probability of S2. In this case, the normalization costs of the respective services are given as G1=(50+100)×(0.2+0.1)=4.5, G2=(100+100+1.5)×0.1=21.5, and G3=(100+50+15)=4.95.

Based on the thus calculated normalized costs, the execution flow determination unit 23 determines the flow in accordance with the decreasing order of the cost. In the present embodiment, the execution order is determined to be G1, G2, and G3 (S1, S4, S2, and S3) (step S173).

In this way, in the present embodiment, the service execution order can be determined in accordance with the normalized costs calculated by grouping the services and considering the interdependency between the respective services. As a result, even in a situation where there is a limitation on the calling order between the plurality of services, the workflow execution control apparatus can provide the workflow process that optimizes the execution of the compensation transaction, and can reduce the processing cost that occurs in the event of an error in the service providing server. Further, by thus optimizing the execution of the compensation transaction and reducing the processing cost, the workflow execution control apparatus can reduce the processing load of the CPU of the service providing servers.

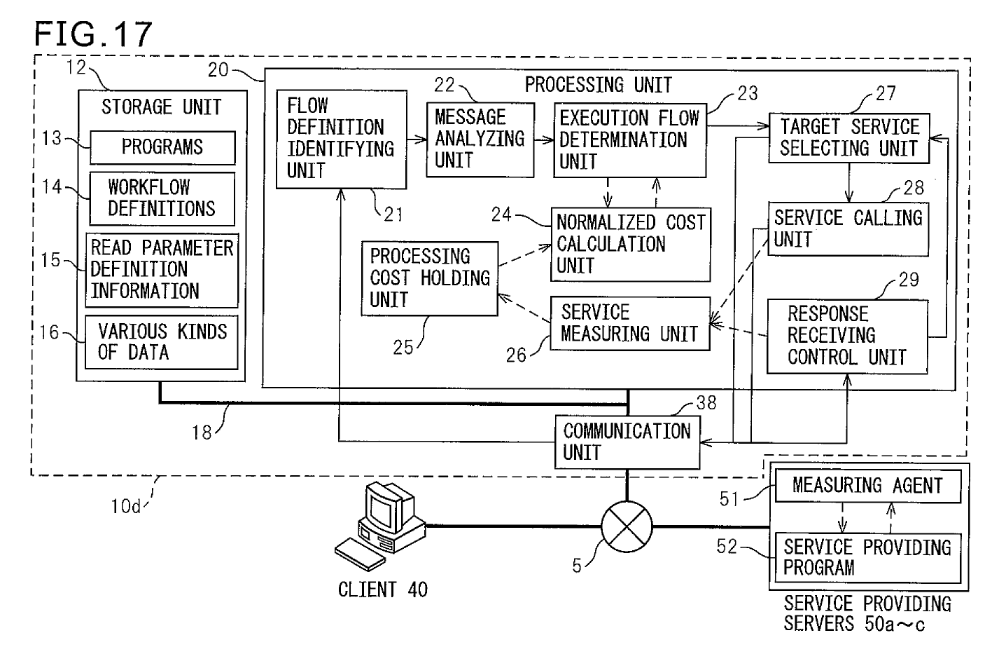

A workflow execution control apparatus 10d according to a fourth embodiment will be described with reference to FIG. 17.

The workflow execution control apparatus 10d is identical in configuration to the workflow execution control apparatus 10a of the first embodiment.

Compared with the first embodiment, the service measuring unit 26 further includes a function that, when the processing result of each service is received, stores the processing time information contained therein as the processing cost into the processing cost holding unit.

Further, each of the service providing servers 50a to 50c functions as a measuring agent 51 by executing a program stored in the storage unit. The measuring agent 51 measures the CPU execution time taken to execute a service providing program 52 from the start to the end of the execution of the service after receiving the request message from the workflow execution control apparatus 10d. Each of the service providing servers 50a to 50c returns the CPU execution time together with the processing result to the workflow execution control apparatus 10d.

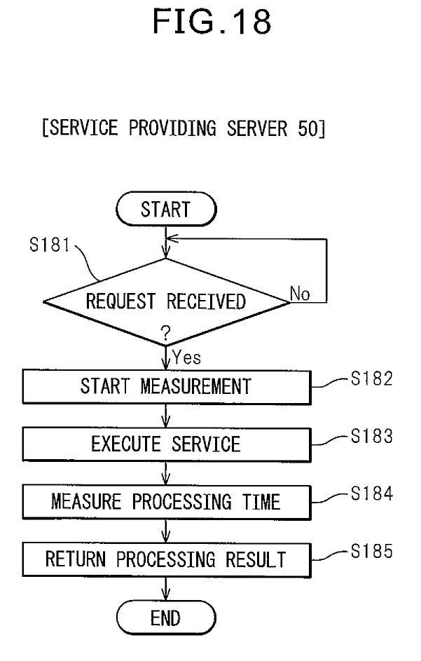

One example of the processing performed by the service providing server will be described with reference to FIG. 18.

To call the reservation of the service S1 “Hotel 1” the service calling unit 28 transmits a request to the service providing server 50 providing the service S1. At the same time, the service calling unit 28 passes the reserved resource (Hotel 1) and its XPath definition (/request/hotel/name/text( )) to the service measuring unit 26. The service providing server 50 waits for the service execution request (step S181). When the service execution request is received, the service providing server 50 executes the service (step S183), and the measuring agent 61 measures the CPU execution time taken from the start to the end of the execution of the service providing program (step S184). In the present embodiment, it is assumed that it takes 30 ms for this execution.

The service providing server 50 returns the CPU execution time together with the processing result to the workflow execution control apparatus 10d (step S185).

The response receiving control unit 29 in the workflow execution control apparatus 10d receives the CPU execution time and the processing result from the service providing server 50, and reports the CPU execution time (30 ms) required, for example, to process the service S1 and the processing result (ERROR) to the service measuring unit 26. The service measuring unit 26 calculates the processing cost using the execution time (30 ms) and updates the corresponding entry of the service S1 in the processing cost holding unit 25.

Since the program execution time at the service providing server 50 can be measured in the above manner, the cost can be measured accurately, for example, even when a waiting time temporarily occurs due to a queue or the like in the service providing server before or after executing the service.

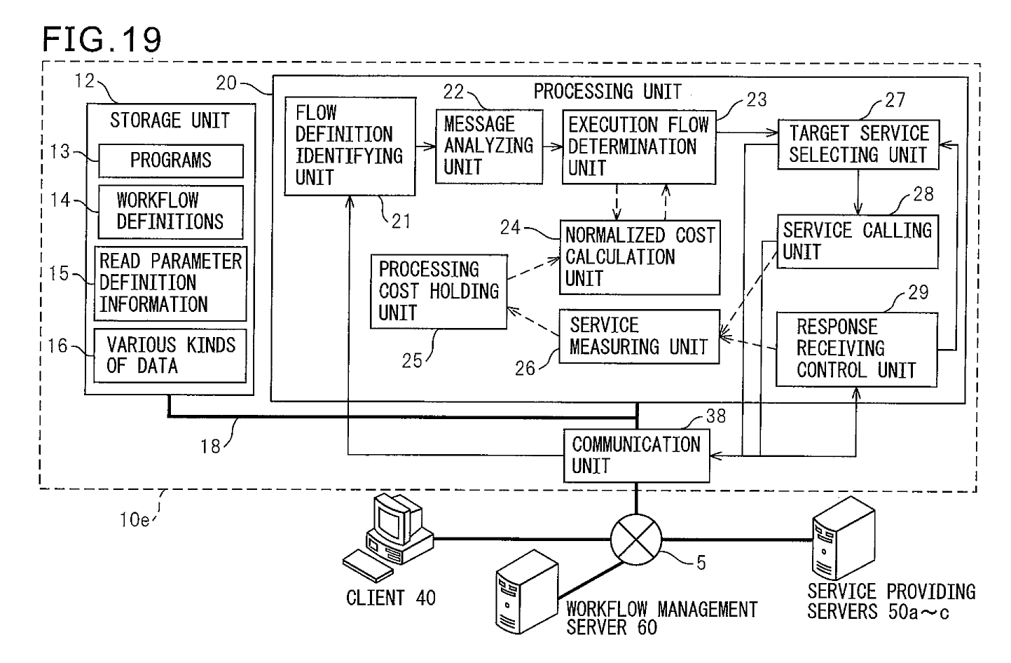

A workflow execution control apparatus 10e according to a fifth embodiment will be described with reference to FIG. 19.

The workflow execution control apparatus 10e is identical in configuration to the workflow execution control apparatus 10a of the first embodiment. Here, the workflow execution control apparatus 10e is connected to a workflow management server 60 via the network 5.

Compared with the first embodiment, the flow definition identifying unit 21 further includes a function that analyzes the contents of the request message received from the client 40 and identifies the workflow to be executed. Further, the flow definition identifying unit 21 transmits a request to the workflow management server 60 via the communication unit 38 to make an inquire about the identified workflow.

The workflow management server 60 is a server for centrally managing the workflow definitions. The workflow management server 60 can respond to the request from the flow definition identifying unit 21 by returning the specified workflow definition.

Next, a description will be given of the operation performed when the request message is received from the client. The client 40 transmits the request message to the workflow execution control apparatus 10e. Here, the contents of the request are the same as those of the message transmitted in step S101 of FIG. 3. When the request is received by the workflow execution control apparatus 10e, the flow definition identifying unit 21 identifies the workflow and recognizes that the workflow “wf1” specified in the request message is to be executed. The flow definition identifying unit 21 transmits a request for acquiring the workflow “wf1” to the workflow management server 60 which, in response, returns the workflow definition of “wf1” to the workflow execution control apparatus 10e. The flow definition identifying unit 21 applies the received workflow definition as the workflow definition of the workflow specified in the request message. Thereafter, the same processing as that in step S103 of FIG. 3 is performed, the description of which will not be repeated here.

The workflow execution control apparatus 10e may cache the workflow definition acquired from the workflow management server 60 and holds it for a specified period of time so that it can be reused.

In this way, when a plurality of workflow execution control apparatus 10 are arranged in parallel, since the workflow definitions can be centrally managed by the workflow management server 60, there is eliminated the need to provide the workflow definition to each server, and the maintenance cost when the workflow definition is changed can be reduced.

A client 40a according to a sixth embodiment will be described with reference to FIG. 20.

The client 40a is connected to a program delivery server 70 via the network. A workflow control program is loaded into the client 40a to implement the various functions of the workflow execution control apparatus described with reference to the first to fifth embodiments, and the workflow control program is executed on the browser within the client 40a.

The workflow control program is stored in the program delivery server 70, and is delivered, for example, as a lava (registered trademark) program that runs on the client.

A description will be given below of how the client acquires the workflow control program. From the browser running on the client 40a, a request is transmitted to the program delivery server 70 to acquire the workflow control program from the program delivery server 70. To execute the workflow control program, a service execution request is entered via the browser. In this case, since the data is transferred within the same machine, the workflow name and reservation resource name may be specified, not in XML message format, but by using program call arguments.

The process after receiving the request is the same as that of the first embodiment, and therefore, the description will not be repeated here.

Here, the workflow control program may be acquired in advance from the program delivery server 70 before issuing the request.

In this way, calls for a plurality of services can be issued from the client without having to install a workflow execution control apparatus, and the processing cost that occurs in the event of an error in any one of the services can also be reduced. Further, by thus reducing the processing cost while also optimizing the execution of the compensation transaction, the client can reduce the processing load of the CPU of the service providing servers.

A workflow execution control apparatus 10f according to a seventh embodiment will be described. To address the situation where the request message from the client 40 is a binary message, the message analyzing unit 22 may have the following function.

Based on a preset definition (byte position and size) for reading a specific location within the message, the message analyzing unit 22 retrieves a parameter (example: name of hotel to be reserved) from the specified location within the message, and passes it to the execution flow determination unit 23.

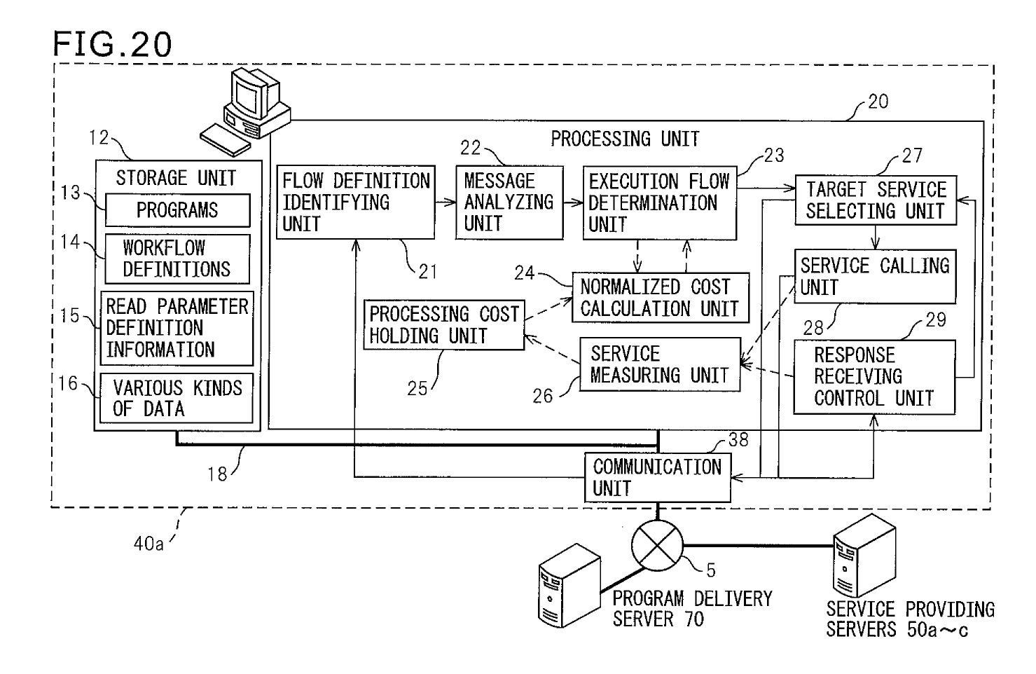

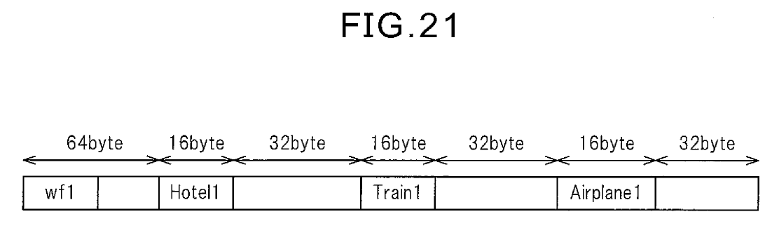

FIG. 21 illustrates one example of the transmission format of the request message. Suppose that in the service execution order determination process of the first embodiment (steps S151 to S155), the request message is transmitted in the format such as shown in FIG. 21 (the contents of the information are the same as those shown in the first embodiment). Then, in the service calling step S152, the message analyzing unit 22 reads out the information of the reservation resources, Hotel 1, Train 1, and Airplane 1, from the received request message.

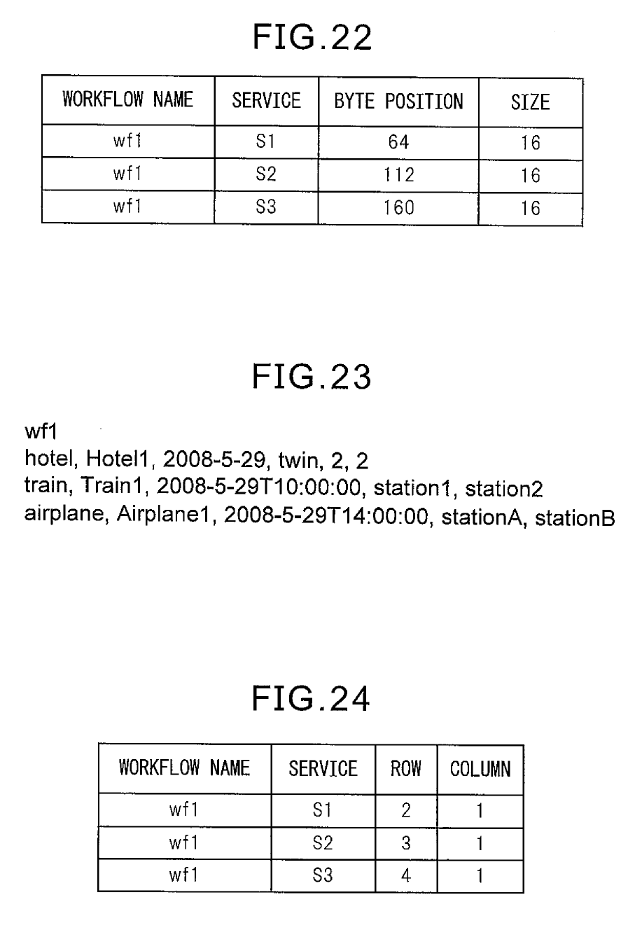

FIG. 22 illustrates one example of the read parameter definition information. When reading out the reservation resource information from the request message, the read location may be specified, for example, by specifying the byte position from the beginning of the message and the number of bytes (size) from that location, as illustrated in FIG. 22. By so doing, the workflow execution order can be controlled even when the message delivered to the workflow execution control apparatus is binary data.

A workflow execution control apparatus 10g according to an eighth embodiment will be described. There may arise a need to handle situations where the request message from the client 40 is in a table format such as CSV (Comma Separated Values). In that case, based on a preset definition (row and column positions) for reading a specific location within the message, the message analyzing unit 22 retrieves a parameter (example: name of hotel to be reserved) from the specified location within the message, and passes it to the execution flow determination unit.

FIG. 23 illustrates one example of the request message. The following description is given for the case where the request message is transmitted in the format such as shown in FIG. 23 (the contents of the information are the same as those shown in the first embodiment).

In the service execution order determination process of the first embodiment (steps S151 to S155), the message analyzing unit 22 in step S152 reads out the information of the reservation resources, Hotel 1, Train 1, and Airplane 1, from the received request message.

FIG. 24 illustrates one example of the read parameter definition information. When reading out the reservation resource information from the request message, the read location may be specified by specifying the row and column positions in the message, as illustrated in FIG. 24. By so doing, the workflow execution order can be controlled even when the message delivered to the workflow execution control apparatus 10 is data organized in a table format such as CSV.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority and inferiority of the invention. Although the embodiment(s) of the present invention have been described in detail, it should be understood that the various changes, substitutions, and alterations could be made hereto without departing from the spirit and scope of the invention.

What is claimed is:

1. A computer readable storage medium storing a workflow execution control program for sequentially calling a plurality of services provided by one or more service providing servers, wherein the program causes a computer connected to the one or more service providing servers to function as:
a service measuring unit for calculating a processing cost and an error occurrence probability for each of the services by using a processing result for each of the services;
a normalized cost calculation unit for calculating for each of the services a normalized cost which is a cost normalized by using the processing cost that occurs in the event of an error in one of the services in order to process other ones of the services and also using the occurrence probability of the error;
an execution flow determination unit for determining an execution order of the services in accordance with the normalized costs calculated for the services; and
a service calling unit for sequentially calling the services from the service providing servers in accordance with the execution order.

2. The computer readable storage medium according to claim 1, wherein the normalized cost calculation unit calculates the normalized cost by using a workflow definition that defines a relationship of interdependency between the plurality of services.

3. The computer readable storage medium according to claim 1, wherein the normalized cost calculation unit calculates the normalized cost for each group of services having a relationship of interdependency, by using a workflow definition that defines the relationship of interdependency between the services, and
the execution flow determination unit determines the execution order on a group-by-group basis in accordance with the normalized cost calculated for each group.

4. The computer readable storage medium according to claim 1, wherein the service measuring unit further acquires a processing time required to execute each of the services from the service providing servers executing the services, and calculates the processing cost for each of the services based on the acquired processing time.

5. The computer readable storage medium according to claim 1, wherein the program causes the computer to further function as:
a message analyzing unit for retrieving an information unit from a specific location within a request message, and wherein:
the normalized cost calculation unit calculates the normalized cost for each retrieved information unit, and
the service measuring unit calculates the processing cost and the error occurrence probability for each information unit.

6. The computer readable storage medium according to claim 1, wherein the processing cost is calculated based on a cancellation processing time that occurs in the event of an error in one of the services in order to cancel other ones of the services and on the processing time required to execute those other services.

7. The computer readable storage medium according to claim 1, wherein the processing cost is a cancellation cost that occurs in the event of an error in one of the services in order to cancel other ones of the services.

8. A workflow execution control apparatus for sequentially calling a plurality of services provided by one or more service providing servers, the apparatus comprising:
a processing cost holding unit for storing an error occurrence probability and a processing cost for each of the services;
a service measuring unit for calculating the processing cost and the error occurrence probability for each of the services by using a processing result for each of the services;
a normalized cost calculation unit for calculating for each of the services a normalized cost which is a cost normalized by using the processing cost that occurs in the event of an error in one of the services in order to process other ones of the services and also using the occurrence probability of the error;
an execution flow determination unit for determining an execution order of the services in accordance with the normalized costs calculated for the services; and
a service calling unit for sequentially calling the services from the service providing servers in accordance with the execution order.

9. The workflow execution control apparatus according to claim 8, wherein the normalized cost calculation unit calculates the normalized cost by using a workflow definition that defines a relationship of interdependency between the plurality of services.

10. The workflow execution control apparatus according to claim 8, wherein the normalized cost calculation unit calculates the normalized cost for each group of services having a relationship of interdependency, by using a workflow definition that defines the relationship of interdependency between the services, and
the execution flow determination unit determines the execution order on a group-by-group basis in accordance with the normalized cost calculated for each group.

11. The workflow execution control apparatus according to claim 8, wherein the service measuring unit further acquires a processing time required to execute each of the services from the service providing servers executing the services, and calculates the processing cost for each of the services based on the acquired processing time.

12. The workflow execution control apparatus according to claim 8, further comprising a message analyzing unit for retrieving an information unit from a specific location within a request message, and wherein:
the normalized cost calculation unit calculates the normalized cost for each retrieved information unit,
the service measuring unit calculates the processing cost and the error occurrence probability for each information unit, and
the processing cost holding unit holds the error occurrence probability and the processing cost for each information unit.

13. The workflow execution control apparatus according to claim 8, wherein the processing cost is calculated based on a cancellation processing time that occurs in the event of an error in one of the services in order to cancel other ones of the services and on the processing time required to execute those other services.

14. The workflow execution control apparatus according to claim 8, wherein the processing cost is a cancellation cost that occurs in the event of an error in one of the services in order to cancel other ones of the services.

15. A workflow execution control method for sequentially calling a plurality of services provided by one or more service providing servers, the method comprising:
calculating a processing cost and an error occurrence probability for each of the services by acquiring a processing result for each of the services from the service providing servers;
calculating for each of the services a normalized cost which is a cost normalized by using the processing cost that occurs in the event of an error in one of the services in order to process other ones of the services and also using the occurrence probability of the error;
determining an execution order of the services in accordance with the normalized costs calculated for the services; and
sequentially calling the services from the service providing servers in accordance with the execution order.

16. The workflow execution control method according to claim 15, wherein the calculating for each of the services a normalized cost includes calculating the normalized cost by using a workflow definition that defines a relationship of interdependency between the plurality of services.

17. The workflow execution control method according to claim 15, wherein the calculating for each of the services a normalized cost includes calculating the normalized cost for each group of services having a relationship of interdependency, by using a workflow definition that defines the relationship of interdependency between the services, and
the determining includes determining the execution order on a group-by-group basis in accordance with the normalized cost calculated for each group.

18. The workflow execution control method according to claim 15, wherein the calculating a processing cost and an error occurrence probability includes acquiring a processing time required to execute each of the services from the service providing servers executing the services, and calculating the processing cost for each of the services based on the acquired processing time.

19. The workflow execution control method according to claim 15, further comprising retrieving an information unit from a specific location within a request message, and wherein:
the calculating a processing cost and an error occurrence probability includes calculating the normalized cost for each retrieved information unit, and,
the calculating for each of the services a normalized cost includes calculating the processing cost and the error occurrence probability for each information unit.

20. The workflow execution control method according to claim 15, wherein the processing cost is calculated based on a cancellation processing time that occurs in the event of an error in one of the services in order to cancel other ones of the services and on the processing time required to execute those other services.
